(19) United States
(12) Patent Application Publication
(10) Pub. No.: US 2026/0295838 A1
(43) Pub. Date: Oct. 1, 2026

(54) ROBOT CONTROL SYSTEM AND CONTROLLER

(71) Applicant: NIDEC INSTRUMENTS CORPORATION, Nagano (JP)

(72) Inventor: Hirokatsu OKUMURA, Nagano (JP)

(73) Assignee: NIDEC INSTRUMENTS CORPORATION, Nagano (JP)

(21) Appl. No.: 19/577,385

(22) Filed: Mar. 25, 2026

(30) Foreign Application Priority Data
Mar. 26, 2025 (JP) 2025-051991

(51) Int. Cl. B25J 9/16; B25J 13/06

(52) U.S. Cl. CPC B25J 9/1674; B25J 13/06; G05B 2219/39001

(57) ABSTRACT

A robot control system includes a control device that outputs an operation command signal for a robot, and a controller that controls an operation of the robot based on the operation command signal from the control device. The controller includes a detection section that detects an error occurring in the robot and the controller, a storage section that stores a definition file in which related information related to error information detected by the detection section is defined, and a transmission section that sends the error information detected by the detection section and the definition file to the control device. The control device includes a determination section that selects, when there are a plurality of pieces of the error information, display error information to be displayed on a display section from the plurality of pieces of the error information, based on the related information of the definition file.

### CROSS-REFERENCE TO RELATED APPLICATION

This application claims the priority benefits of Japanese application no. 2025-051991, filed on Mar. 26, 2025. The entirety of the above-mentioned patent application is hereby incorporated by reference herein and made a part of this specification.

### BACKGROUND

### Field of the Invention

The present disclosure relates to a robot control system and a controller.

### Description of the Related Documents

A robot control system for controlling a robot is described in Japanese Unexamined Patent Application Publication No. 2021-171890. The robot control system of Japanese Unexamined Patent Application Publication No. 2021-171890 includes a robot, a host control device that outputs an operation command signal for the robot, and a controller that controls an operation of the robot based on the operation command signal from the control device.

In a robot control system, various errors may occur in a robot, a controller, or the like. When an error occurs, an error detection section provided in the controller detects all errors, and a transmission section provided in the controller transmits all detected error information to a host control device. The control device displays all of the transmitted error information on a display section.

Here, there may be a clear causal relationship in causes of error occurrence. In this case, a user selects error information that is a source of one of the causes of the error occurrence from a plurality of pieces of error information displayed on the display section, and performs maintenance work on the robot control system, based on the selected error information.

However, for some users, it may be difficult to appropriately select the error information that is the source of one of the causes of the error occurrence from the plurality of pieces of error information, and as a result, there is a problem that the maintenance work cannot be performed quickly.

In view of the above problems, an object of the present disclosure is to provide a robot control system and a controller that allow any user to appropriately select error information that is a source of a cause of error occurrence from a plurality of pieces of error information.

### SUMMARY

In order to solve the above problems, an aspect of a robot control system of at least an embodiment of the present invention is a robot control system that controls an operation of a robot, the robot control system including: a control device that outputs an operation command signal for the robot; and a controller that controls the operation of the robot based on the operation command signal from the control device. The controller includes: a detection section that detects an error occurring in the robot and the controller; a storage section that stores a definition file in which related information related to error information detected by the detection section is defined; and a transmission section that sends, to the control device, the error information detected by the detection section and the definition file. The control device includes a determination section that, when there are a plurality of pieces of the error information, selects display error information to be displayed on a display section from the plurality of pieces of the error information sent from the transmission section, based on the related information of the definition file sent from the transmission section.

An aspect of a controller of at least an embodiment of the present invention is a controller that controls an operation of a robot based on an operation command signal from a control device, the controller including: a detection section that detects occurrence of an error; a storage section that stores a definition file in which related information related to error information detected by the detection section is defined; and a determination section that, when there are a plurality of pieces of the error information, selects display error information to be displayed on a display section from the plurality of pieces of the error information, based on the related information of the definition file.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a block diagram of a robot control system according to a first embodiment;

FIG. 2 is a schematic diagram of a controller, a cable, and a robot;

FIG. 3 is a schematic diagram of an external power supply and a power supply circuit; and

FIG. 4 is a block diagram of a robot control system according to a second embodiment.

### DETAILED DESCRIPTION

Hereinafter, embodiments of a robot control system 100 to which at least an embodiment of the present invention is applied will be described with reference to the drawings.

### First Embodiment

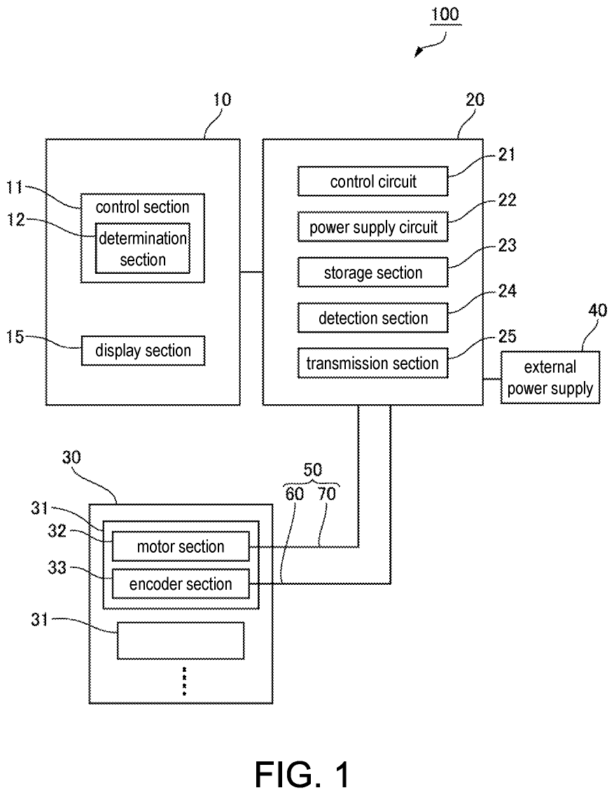

FIG. 1 is a block diagram of a robot control system according to a first embodiment. A robot control system 100 of the present embodiment is used to control an industrial robot 30. The robot 30 includes a plurality of motor units 31 for driving a robot arm or the like. The motor unit 31 includes a motor section 32 that drives the robot arm or the like, and an encoder section 33 that detects a rotational position of the motor section 32.

The robot control system 100 includes a control device 10 and a controller 20. The control device 10 is a computer or the like that is a host device of the controller 20, outputs an operation command signal for the robot 30 to the controller 20, and displays an error occurring in the robot control system 100. Various functions of the control device 10 are set by information input from an input means or the like. The control device 10 includes a control section 11 and a display section 15. The control section 11 is a CPU or the like and controls the control device 10. The control section 11 displays error information transmitted from the controller 20 on the display section 15. The control section 11 includes a determination section 12 that selects error information to be displayed on the display section 15 when there are a plurality of pieces of error information transmitted from the controller 20. The display section 15 is a monitor or the like.

The controller 20 controls an operation of the robot 30, based on the operation command signal from the control device 10. The controller 20 includes a control circuit 21, a power supply circuit 22, a storage section 23, a detection section 24, and a transmission section 25.

The control circuit 21 is connected to the robot 30 via a communication cable 70, and controls the robot 30, based on the operation command signal from the control device 10. The power supply circuit 22 converts a voltage input from an external power supply 40. For example, the power supply circuit 22 converts an AC voltage of 220 V input from the external power supply 40 into a DC voltage of 24 V or a DC voltage of 5 V, and supplies the converted DC voltage to each electric component of the controller 20. Further, the power supply circuit 22 supplies the converted DC voltage to the robot 30 via a power cable 60. Here, in the present embodiment, the power cable 60 and the communication cable 70 are configured by a single cable 50.

The detection section 24 detects an error occurring in the robot 30 and the controller 20. In the present embodiment, the detection section 24 is provided in the control circuit 21. The storage section 23 stores a definition file in which related information related to error information detected by the detection section 24 is defined. The definition file is a file in a format that allows data to be structured and saved, such as an XML format or a CSV format. In the present embodiment, the related information defined in the definition file includes at least hierarchical information in which causes of occurrence of a plurality of pieces of error information are associated, and combination error information in which a plurality of pieces of error information are combined. The transmission section 25 sends the error information detected by the detection section 24 and the definition file to the control device 10.

Here, when there are a plurality of pieces of error information transmitted to the control device 10, the determination section 12 selects error information (display error information) to be displayed on the display section 15 from the plurality of pieces of error information sent from the transmission section 25, based on the related information of the definition file sent from the transmission section 25. The control section 11 displays the selected error information on the display section 15. Accordingly, only some of the error information selected based on the related information of the definition file from among the plurality of pieces of error information is displayed on the display section 15. Note that a user using the robot control system 100 can also display all of the plurality of pieces of error information sent from the transmission section 25 on the display section 15 by setting the control device 10.

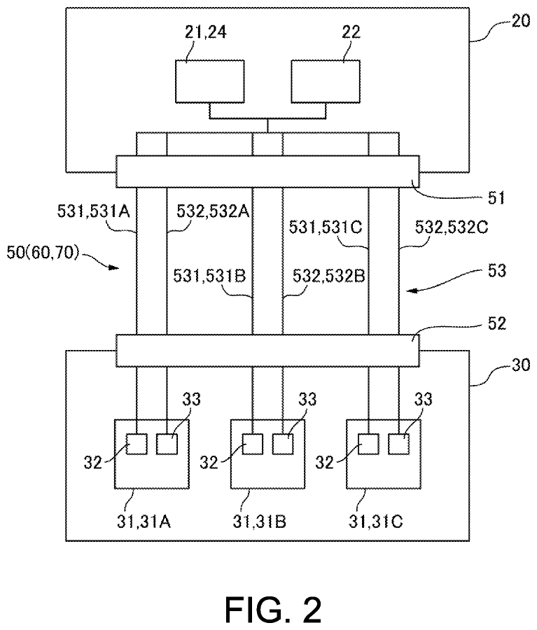

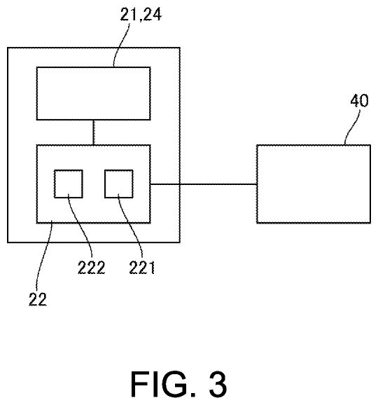

Next, selection of error information in the determination section 12 will be described. FIG. 2 is a schematic diagram of the controller 20, the cable 50, and the robot 30. FIG. 3 is a schematic diagram of the external power supply 40 and the power supply circuit 22.

### Example 1 of Selection of Error Information

As illustrated in FIG. 2, the cable 50 includes a connector 51 connected to the controller 20, a connector 52 connected to the robot 30, and wiring 53 connected to the controller 20 and the robot 30. In the present embodiment, as an example, since the robot 30 includes three motor units 31, the wiring 53 includes a communication line 531 that communicates with each encoder section 33 of the motor unit 31, and a power line 532 that supplies power to each motor section 32 of the motor unit 31. The communication line 531 corresponds to a communication cable, and the power line 532 corresponds to a power cable. The detection section 24 detects disconnection of each communication line 531, a communication abnormality occurring in each communication line 531, an information abnormality occurring in each communication line 531, and disconnection of each power line 532 as errors.

Here, an example of the communication abnormality occurring in the communication line 531 is a case where external noise occurs in the communication line 531 and noise is added to a signal of the communication line 531. When noise is added to the signal of the communication line 531 and the signal of the communication line 531 is disturbed, the detection section 24 detects an error assuming that the communication abnormality has occurred in the communication line 531. Also, when the communication line 531 is disconnected, since no signal flows through the communication line 531 due to the disconnection of the communication line 531, the detection section 24 detects an error assuming that the communication abnormality has occurred in the communication line 531.

As an example of the information abnormality occurring in the communication line 531, when the communication line 531 is not connected to a correct device, information different from information originally obtained is obtained from the communication line 531. Therefore, when information different from information originally obtained is obtained from the communication line 531, the detection section 24 detects an error assuming that the information abnormality has occurred in the communication line 531. Further, also when a communication abnormality occurs in the communication line 531, since information different from information originally obtained is obtained from the communication line 531 due to the communication abnormality of the communication line 531, the detection section 24 detects an error assuming that the communication abnormality has occurred in the communication line 531.

For example, when the communication line 531A connected to the encoder section 33 of the motor unit 31A is disconnected and the power line 532C connected to the motor section 32 of the motor unit 31C is disconnected, the detection section 24 detects an error indicating that the communication line 531A is disconnected, an error indicating that a communication abnormality is occurring in the communication line 531A, an error indicating that an information abnormality is occurring in the communication line 531A, and an error indicating that the power line 532C is disconnected. The transmission section 25 sends, to the control device 10, the definition file and “disconnection of communication line 531A”, “communication abnormality of communication line 531A”, “information abnormality of communication line 531A”, and “disconnection of power line 532C”, which are the error information detected by the detection section 24.

Here, the related information of the definition file includes hierarchical information in which causes of occurrence of a plurality of pieces of error information are associated. In the hierarchical information, as an example, “disconnection of communication line 531”, “communication abnormality of communication line 531”, and “information abnormality of communication line 531” are associated in order from an upper hierarchy to a lower hierarchy, based on a causal relationship. Note that in the present embodiment, “disconnection of power line 532” is not in the hierarchical information because there is no other error having a causal relationship.

Based on the hierarchical information, the determination section 12 selects, as the error information to be displayed on the display section 15, the error information “disconnection of communication line 531A” corresponding to the highest hierarchy of the hierarchical information from among “disconnection of communication line 531A”, “communication abnormality of communication line 531A”, and “information abnormality of communication line 531A”, which are the plurality of pieces of error information. The control section 11 displays the selected error information “disconnection of communication line 531A” on the display section 15. Further, the control section 11 displays “disconnection of power line 532” on the display section 15.

Further, for example, when a communication abnormality has occurred in the communication line 531A connected to the encoder section 33 of the motor unit 31A due to an influence of external noise, the detection section 24 detects an error indicating that the communication abnormality is occurring in the communication line 531A and an error indicating that an information abnormality is occurring in the communication line 531A. The transmission section 25 sends, to the control device 10, the definition file and “communication abnormality of communication line 531A” and “information abnormality of communication line 531A”, which are the error information detected by the detection section 24.

Based on the hierarchical information, the determination section 12 selects, as the error information to be displayed on the display section 15, the error information “communication abnormality of communication line 531A” corresponding to the highest hierarchy of the hierarchical information from among “communication abnormality of communication line 531A” and “information abnormality of communication line 531A”, which are the plurality of pieces of error information. The control section 11 displays the selected error information “communication abnormality of communication line 531A” on the display section 15.

Further, for example, assume that the communication line 531A connected to the encoder section 33 of the motor unit 31A is disconnected, a communication abnormality has occurred in the communication line 531B connected to the encoder section 33 of the motor unit 31B due to an influence of external noise, an information abnormality has occurred in the communication line 531C connected to the encoder section 33 of the motor unit 31C, the power line 532A connected to the motor section 32 of the motor unit 31A is disconnected, and the power line 532C connected to the motor section 32 of the motor unit 31C is disconnected. In this case, the detection section 24 detects an error indicating that the communication line 531A is disconnected, an error indicating that a communication abnormality is occurring in the communication line 531A, an error indicating that an information abnormality is occurring in the communication line 531A, an error indicating that a communication abnormality is occurring in the communication line 531B, an error indicating that an information abnormality is occurring in the communication line 531B, an error indicating that an information abnormality is occurring in the communication line 531C, an error indicating that the power line 532A is disconnected, and an error indicating that the power line 532C is disconnected.

The transmission section 25 sends, to the control device 10, the definition file and “disconnection of communication line 531A”, “communication abnormality of communication line 531A”, “information abnormality of communication line 531A”, “communication abnormality of communication line 531B”, “information abnormality of communication line 531B”, “information abnormality of communication line 531C”, “disconnection of power line 532A”, and “disconnection of power line 532C”, which are the error information detected by the detection section 24.

Based on the hierarchical information, the determination section 12 selects, as the error information to be displayed on the display section 15, the error information “disconnection of communication line 531A” corresponding to the highest hierarchy of the hierarchical information from among “disconnection of communication line 531A”, “communication abnormality of communication line 531A”, and “information abnormality of communication line 531A”, which are the plurality of pieces of error information. Further, the determination section 12 selects, as the error information to be displayed on the display section 15, the error information “communication abnormality of communication line 531B” corresponding to the highest hierarchy of the hierarchical information from among “communication abnormality of communication line 531B” and “information abnormality of communication line 531B”, which are the plurality of pieces of error information. The control section 11 displays the selected error information “disconnection of communication line 531A” and “communication abnormality of communication line 531B” on the display section 15. Further, the control section 11 displays the error information “information abnormality of communication line 531C”, “disconnection of power line 532A”, and “disconnection of power line 532C” on the display section 15.

Note that the determination section 12 does not select the error information “information abnormality of communication line 531C” because there is no other error information related to “information abnormality of communication line 531C”. Therefore, the control section 11 displays “information abnormality of communication line 531C” as it is on the display section 15.

Further, for example, when the connector 51 or the connector 52 of the cable 50 is disconnected, it is the same as a state in which each communication line 531 and each power line 532 are disconnected. Therefore, the detection section 24 detects an error indicating that each communication line 531 is disconnected, an error indicating that a communication abnormality is occurring in each communication line 531, an error indicating that an information abnormality is occurring in each communication line 531, and an error indicating that each power line 532 is disconnected. The transmission section 25 sends, to the control device 10, the definition file and “disconnection of communication line 531A”, “communication abnormality of communication line 531A”, “information abnormality of communication line 531A”, “disconnection of communication line 531B”, “communication abnormality of communication line 531B”, “information abnormality of communication line 531B”, “disconnection of communication line 531C”, “communication abnormality of communication line 531C”, “information abnormality of communication line 531C”, “disconnection of power line 532A”, “disconnection of power line 532B”, and “disconnection of power line 532C”, which are the error information detected by the detection section 24.

Here, the related information of the definition file includes combination error information including combination information in which a plurality of pieces of error information are combined and specific error information specified from the combination information. In the combination error information, as an example, combination information in which “disconnection of communication line 531A”, “communication abnormality of communication line 531A”, “information abnormality of communication line 531A”, “disconnection of communication line 531B”, “communication abnormality of communication line 531B”, “information abnormality of communication line 531B”, “disconnection of communication line 531C”, “communication abnormality of communication line 531C”, “information abnormality of communication line 531C”, “disconnection of power line 532A”, “disconnection of power line 532B”, and “disconnection of power line 532C” are combined is associated with specific error information “connector not connected” specified from the combination information.

The determination section 12 determines whether the combination of the plurality of pieces of error information corresponds to the combination information, based on the combination error information. In the present embodiment, based on the combination error information, the combination of “disconnection of communication line 531A”, “communication abnormality of communication line 531A”, “information abnormality of communication line 531A”, “disconnection of communication line 531B”, “communication abnormality of communication line 531B”, “information abnormality of communication line 531B”, “disconnection of communication line 531C”, “communication abnormality of communication line 531C”, “information abnormality of communication line 531C”, “disconnection of power line 532A”, “disconnection of power line 532B”, and “disconnection of power line 532C” corresponds to the combination information. Therefore, the determination section 12 determines that the combination of the plurality of pieces of error information corresponds to the combination information, based on the combination error information, and selects the specific error information “connector not connected” specified from the combination information corresponding to the determination as the error information to be displayed on the display section 15. The control section 11 displays “connector not connected” on the display section 15.

Note that when the determination section 12 determines that the combination of the plurality of pieces of error information does not correspond to the combination information, based on the combination error information, the determination section 12 selects, as the display error information, the error information corresponding to the highest hierarchy of the hierarchical information from among the plurality of pieces of error information, based on the hierarchical information. The control section 11 displays the selected error information on the display section 15. However, when the determination section 12 does not select the display error information to be displayed on the display section 15 from the plurality of pieces of error information, based on the related information, the control section 11 displays all of the error information on the display section 15.

### Example 2 of Selection of Error Information

As illustrated in FIG. 3, the power supply circuit 22 includes, as an example, a first converter 221 that converts an AC voltage input from the external power supply 40 into a DC voltage, and a second converter 222 that converts the DC voltage from the first converter 221 into a lower potential. For example, the AC voltage input from the external power supply 40 is 220 V. The DC voltage converted by the first converter 221 is 24 V. The DC voltage converted by the second converter 222 is 8 V. When an abnormality occurs in the voltage of the external power supply 40 input to the first converter 221, the voltage converted by the first converter 221, and the voltage converted by the second converter 222, the detection section 24 detects an error assuming that an abnormality has occurred in the voltage.

Here, as an example of an abnormality in the voltage converted by the first converter 221, when the voltage of the input external power supply 40 is not 220 V but abnormal, the first converter 221 cannot convert the voltage into 24 V which is a normal voltage, so that the voltage converted by the first converter 221 becomes abnormal instead of 24 V. As an example of an abnormality in the voltage converted by the second converter 222, when the voltage converted by the first converter 221 is not 24 V but abnormal, the second converter 222 cannot convert the voltage into 8 V which is a normal voltage, so that the voltage converted by the second converter 222 becomes abnormal instead of 8 V.

For example, when an abnormality occurs in the voltage input to the first converter 221, the detection section 24 detects an error assuming that an abnormality has occurred in the voltage input to the first converter 221, the voltage converted by the first converter 221, and the voltage converted by the second converter 222. The transmission section 25 sends, to the control device 10, the definition file and “voltage abnormality of external power supply 40”, “converted voltage abnormality of first converter 221”, and “converted voltage abnormality of second converter 222”, which are the error information detected by the detection section 24.

Here, in the hierarchical information of the definition file, as an example, “voltage abnormality of external power supply 40”, “converted voltage abnormality of first converter 221”, and “converted voltage abnormality of second converter 222” are associated in order from an upper hierarchy to a lower hierarchy, based on a causal relationship.

Based on the hierarchical information, the determination section 12 selects, as the error information to be displayed on the display section 15, the error information “voltage abnormality of external power supply 40” corresponding to the highest hierarchy of the hierarchical information from among “voltage abnormality of external power supply 40”, “converted voltage abnormality of first converter 221”, and “converted voltage abnormality of second converter 222”, which are the plurality of pieces of error information. The control section 11 displays the selected error information “voltage abnormality of external power supply 40” on the display section 15.

### Functions and Effects

The robot control system 100 includes the control device 10 that outputs the operation command signal for the robot 30, and the controller 20 that controls the operation of the robot 30 based on the operation command signal from the control device 10. The controller 20 includes the detection section 24 that detects an error occurring in the robot 30 and the controller 20, the storage section 23 that stores the definition file in which the related information related to the error information detected by the detection section 24 is defined, and the transmission section 25 that sends the error information detected by the detection section 24 and the definition file to the control device 10. The control device 10 includes the determination section 12 that, when there are a plurality of pieces of error information, selects error information (display error information) to be displayed on the display section 15 from the plurality of pieces of error information sent from the transmission section 25, based on the related information of the definition file sent from the transmission section 25. Accordingly, when there are a plurality of pieces of error information, the determination section 12 can select only the error information that is a source of the cause of the error occurrence from the plurality of pieces of error information, based on the related information, so that appropriate error information is displayed on the display section 15. As a result, the user can quickly perform maintenance work of the robot control system 100, based on the appropriate error information displayed on the display section 15.

The related information includes hierarchical information in which causes of occurrence of the plurality of pieces of error information are associated. The determination section 12 selects, as the error information, error information corresponding to the highest hierarchy of the hierarchical information from among the plurality of pieces of error information, based on the hierarchical information. Accordingly, the determination section 12 can select only the error information of the upper hierarchy that is a source of the cause of the error occurrence from the plurality of pieces of error information, based on the hierarchical information, so that appropriate error information is displayed on the display section 15. As a result, the user does not need to select the error information of the upper hierarchy that is a source of the cause of the error occurrence from the plurality of pieces of error information by himself/herself, so that the maintenance work can be quickly performed.

The related information includes combination error information in which combination information obtained by combining a plurality of pieces of error information and specific error information specified from the combination information are associated. The determination section 12 determines whether a combination of the plurality of pieces of error information corresponds to the combination information, based on the combination error information, and selects the specific error information specified from the combination information as the error information (display error information) when the combination of the plurality of pieces of error information corresponds to the combination information. Accordingly, the determination section 12 can select only the error information specified from the combination of the plurality of errors from among the plurality of pieces of error information, based on the combination error information, so that appropriate error information is displayed on the display section 15. As a result, the user does not need to select the error information specified from the combination of the plurality of errors from among the plurality of pieces of error information by himself/herself, so that the maintenance work can be quickly performed.

### Second Embodiment

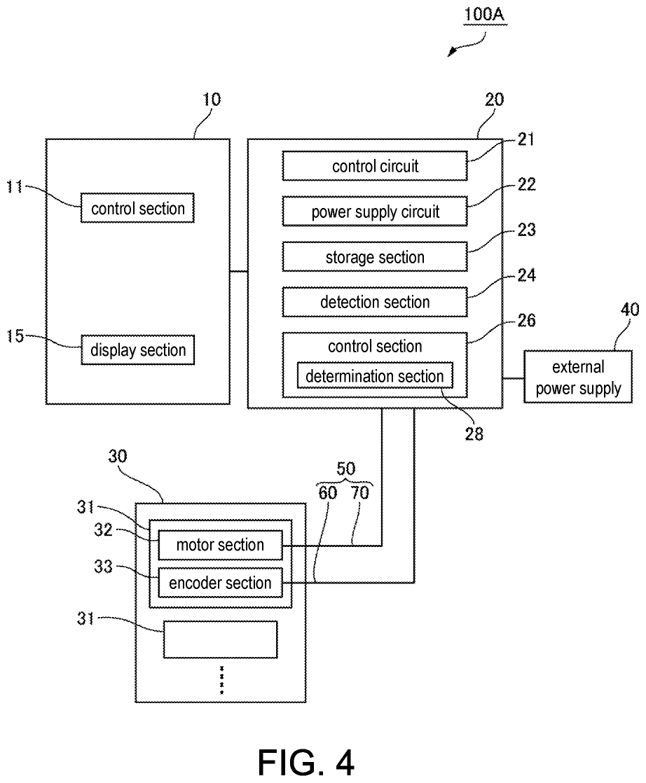

FIG. 4 is a block diagram of a robot control system 100A according to a second embodiment. In the robot control system 100A of the second embodiment illustrated in FIG. 4, the controller 20 includes a determination section 28, which is different from the controller 20 of the robot control system 100 of the first embodiment. Therefore, in the second embodiment, the same components as those in the first embodiment are denoted by the same reference numerals, and description thereof may be omitted.

The robot control system 100A includes a control device 10 and a controller 20. The control device 10 is a computer or the like that is a host device of the controller 20, outputs an operation command signal for the robot 30 to the controller 20, and displays an error occurring in the robot control system 100. Various functions of the control device 10 are set by information input from an input means or the like. The control device 10 includes a control section 11 and a display section 15. The control section 11 is a CPU or the like and controls the control device 10. The control section 11 displays error information transmitted from the controller 20 on the display section 15. The display section 15 is a monitor or the like.

The controller 20 controls an operation of the robot 30, based on the operation command signal from the control device 10. The controller 20 includes a control circuit 21, a power supply circuit 22, a storage section 23, a detection section 24, and a control section 26. The control section 26 is a CPU, a microcomputer, or the like. The control section 26 includes a determination section 28 that selects error information to be displayed on the display section 15 when there are a plurality of pieces of error information transmitted from the controller 20. When the detection section 24 detects a plurality of pieces of error information, the determination section 28 selects error information (display error information) to be displayed on the display section 15 from among the plurality of pieces of error information, based on related information of a definition file. When the determination section 28 selects the error information to be displayed, the control section 11 sends the selected error information and the error information not selected by the determination section 28 to the control device 10. The control section 11 of the control device 10 displays the selected error information and the error information not selected by the determination section 28 on the display section 15.

Note that the control section 11 may send the selected error information and the error information not selected by the determination section 28 to a teaching pendant connected to the controller 20. In this case, the selected error information and the error information not selected by the determination section 28 are displayed on a display section of the teaching pendant.

### Functions and Effects

The controller 20 includes the detection section 24 that detects occurrence of an error, the storage section 23 that stores a definition file in which related information related to the error information detected by the detection section 24 is defined, and the determination section 28 that, when there are the plurality of pieces of error information, selects error information (display error information) to be displayed on the display section 15 from among a plurality of pieces of error information, based on the related information of the definition file. Accordingly, the robot control system 100A of the second embodiment can obtain the same functions and effects as those of the robot control system 100 of the first embodiment.

### Modifications

Errors that can be detected by the detection section 24 are not limited to the above embodiments. The detection section 24 can be configured to detect various errors as necessary.

The hierarchical information stored in the definition file is not limited to the above embodiments. As long as the hierarchical information is associated based on causes of occurrence of a plurality of pieces of error information in order from an upper hierarchy to a lower hierarchy, the hierarchical information may be defined by any error information.

The combination error information stored in the definition file is not limited to the above embodiments. The combination error information may be defined by combining a plurality of any pieces of error information.

In the above embodiment, the power line 532 and the communication line 531 are connected to the motor unit 31, but the power line 532 and the communication line 531 may be connected to an aligner that performs alignment of a conveyed object conveyed by the robot 30. Further, the power line 532 and the communication line 531 may be connected to other devices.

Note that the present technology can also be configured as follows.

### Supplementary Note 1

A robot control system for controlling an operation of a robot, the robot control system including:
a control device that outputs an operation command signal for the robot; and
a controller that controls the operation of the robot based on the operation command signal from the control device, wherein
the controller includes: a detection section that detects an error occurring in the robot and the controller; a storage section that stores a definition file in which related information related to error information detected by the detection section is defined; and a transmission section that sends, to the control device, the error information detected by the detection section and the definition file, and
the control device includes a determination section that selects, when there are a plurality of pieces of the error information, display error information to be displayed on a display section from among the plurality of pieces of the error information sent from the transmission section, based on the related information of the definition file sent from the transmission section.

### Supplementary Note 2

The robot control system according to supplementary note 1, wherein
the related information includes hierarchical information in which causes of occurrence of the plurality of pieces of the error information are associated, and
the determination section selects, as the display error information, error information corresponding to a highest hierarchy of the hierarchical information from among the plurality of pieces of error information, based on the hierarchical information.

### Supplementary Note 3

The robot control system according to supplementary note 1 or 2, wherein
the related information includes combination error information in which combination information obtained by combining a plurality of pieces of the error information is associated with specific error information specified from the combination information, and
the determination section determines whether a combination of the plurality of pieces of the error information corresponds to the combination information, based on the combination error information, and selects the specific error information specified from the combination information as the display error information when the combination of the plurality of pieces of the error information corresponds to the combination information.

### Supplementary Note 4

The robot control system according to any one of supplementary notes 1 to 3, wherein
the controller includes a power supply circuit that converts a voltage input from an external power supply and supplies the converted voltage to the robot via a power cable, and
the detection section detects an error occurring in the power supply circuit or an error occurring in the power cable as the error information.

### Supplementary Note 5

The robot control system according to any one of supplementary notes 1 to 4, wherein
the controller includes a control circuit that controls the operation of the robot via a communication cable, and
the detection section detects an error occurring in the communication cable as the error information.

### Supplementary Note 6

A controller for controlling an operation of a robot based on an operation command signal from a control device, the controller including:
a detection section that detects occurrence of an error;
a storage section that stores a definition file in which related information related to error information detected by the detection section is defined; and
a determination section that selects, when there are a plurality of pieces of the error information, display error information to be displayed on a display section from the plurality of pieces of the error information, based on the related information of the definition file.

### Supplementary Note 7

The controller according to supplementary note 6, wherein
the related information includes hierarchical information in which causes of occurrence of the plurality of pieces of the error information are associated, and
the determination section selects, as the display error information, error information corresponding to a highest hierarchy of the hierarchical information from among the plurality of pieces of the error information, based on the hierarchical information.

### Supplementary Note 8

The controller according to supplementary note 6 or 7, wherein
the related information includes combination error information in which combination information obtained by combining a plurality of pieces of the error information is associated with specific error information specified from the combination information, and
the determination section selects, based on the combination error information, the specific error information specified from the combination information as the display error information when a combination of the plurality of pieces of the error information corresponds to the combination information.

What is claimed is:

1. A robot control system for controlling an operation of a robot, comprising:
a control device that outputs an operation command signal for the robot; and
a controller that controls the operation of the robot based on the operation command signal from the control device, wherein
the controller comprises: a detection section that detects an error occurring in the robot and the controller; a storage section that stores a definition file in which related information related to error information detected by the detection section is defined; and a transmission section that sends the error information detected by the detection section and the definition file to the control device, and
the control device comprises a determination section that selects, when there are a plurality of pieces of the error information, display error information to be displayed on a display section from among the plurality of pieces of the error information sent from the transmission section, based on the related information of the definition file sent from the transmission section.

2. The robot control system according to claim 1, wherein
the related information includes combination error information in which combination information obtained by combining a plurality of pieces of the error information is associated with specific error information specified from the combination information, and
the determination section determines whether a combination of the plurality of pieces of the error information corresponds to the combination information, based on the combination error information, and selects the specific error information specified from the combination information as the display error information when the combination of the plurality of pieces of the error information corresponds to the combination information.

3. The robot control system according to claim 1, wherein
the related information includes hierarchical information in which causes of occurrence of the plurality of pieces of the error information are associated, and
the determination section selects, as the display error information, error information corresponding to a highest hierarchy of the hierarchical information from among the plurality of pieces of the error information, based on the hierarchical information.

4. The robot control system according to claim 3, wherein
the related information includes combination error information in which combination information obtained by combining a plurality of pieces of the error information is associated with specific error information specified from the combination information, and
the determination section determines whether a combination of the plurality of pieces of the error information corresponds to the combination information, based on the combination error information, and selects the specific error information specified from the combination information as the display error information when the combination of the plurality of pieces of the error information corresponds to the combination information.

5. The robot control system according to claim 1, wherein
the controller comprises a power supply circuit that converts a voltage input from an external power supply and supplies the converted voltage to the robot via a power cable, and
the detection section detects an error occurring in the power supply circuit or an error occurring in the power cable as the error information.

6. The robot control system according to claim 1, wherein
the controller comprises a control circuit that controls the operation of the robot via a communication cable, and
the detection section detects an error occurring in the communication cable as the error information.

7. A controller for controlling an operation of a robot based on an operation command signal from a control device, the controller comprising:
a detection section that detects occurrence of an error;
a storage section that stores a definition file in which related information related to error information detected by the detection section is defined; and
a determination section that selects, when there are a plurality of pieces of the error information, display error information to be displayed on a display section from among the plurality of pieces of the error information, based on the related information of the definition file.

8. The controller according to claim 7, wherein
the related information includes combination error information in which combination information obtained by combining a plurality of pieces of the error information is associated with specific error information specified from the combination information, and
the determination section selects, based on the combination error information, the specific error information specified from the combination information as the display error information when a combination of the plurality of pieces of the error information corresponds to the combination information.

9. The controller according to claim 7, wherein
the related information includes hierarchical information in which causes of occurrence of the plurality of pieces of the error information are associated, and
the determination section selects, as the display error information, error information corresponding to a highest hierarchy of the hierarchical information from among the plurality of pieces of the error information, based on the hierarchical information.

10. The controller according to claim 9, wherein
the related information includes combination error information in which combination information obtained by combining a plurality of pieces of the error information is associated with specific error information specified from the combination information, and
the determination section selects, based on the combination error information, the specific error information specified from the combination information as the display error information when a combination of the plurality of pieces of the error information corresponds to the combination information.
